(19) United States
(12) Patent Application Publication
(10) Pub. No.: US 2008/0295950 A1
(43) Pub. Date: Dec. 4, 2008

(54) Open Grid Fabric Resin Infusion Media and Reinforcing Composite Lamina

(76) Inventors: Patrick E. Mack, Milford, MA (US); Mitchell D. Smith, Abingdon, VA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/191,018

(22) Filed: Aug. 13, 2008

Related U.S. Application Data
(62) Division of application No. 10/914,931, filed on Aug. 10, 2004.
(60) Provisional application No. 60/493,639, filed on Aug. 11, 2003.

(51) Int. Cl. B32B 38/08

(52) U.S. Cl. 156/145

(57) ABSTRACT

An open grid fabric resin infusion medium and reinforcing composite lamina used in the manufacture of fiber reinforced polymer resin composites. The use of the open grid fabric as at least one of a composite lamina provides significant improvements in both the resin infusion rate and resin distribution uniformity throughout the laminate.

### CROSS REFERENCE TO RELATED APPLICATION

This application is a divisional of, and claims priority from, co-pending U.S. patent application Ser. No. 10/914,931, entitled “Open Grid Fabric Resin Infusion Media and Reinforcing Composite Lamina,” filed Aug. 10, 2004, to Patrick E. Mack and Mitchell D. Smith, the entire content of which is incorporated by reference herein, and which is based on and claims the benefit of priority of U.S. Provisional Patent Application Ser. No. 60/493,639, filed on Aug. 11, 2003, the disclosure of which is expressly incorporated by reference herein in its entirety.

### FIELD OF THE INVENTION

The present invention relates to the novel use of an open grid fabric resin infusion medium and reinforcing composite lamina in the manufacture of fiber reinforced polymer resin composites.

### BACKGROUND OF THE INVENTION

Fiber reinforced resin composite structures are used in various industries, including the manufacture of parts and finished goods in automotive, recreation vehicle, trucking, aerospace, marine, rail, appliance, athletic equipment, container, construction, anti-corrosion, electrical and medical industries. There are several generally known technical approaches to the forming of fiber reinforced laminate composites.

For instance, a typical open mold laminating process for constructing composite components or articles generally comprises laying or placing either dry fibers or previously resin-impregnated fibers (also known as “pre-pregs”) into an open mold of the desired shape. The dry fiber reinforcements are then saturated with liquid resin using manual techniques such as hand wet-out or spray application (processes commonly referred to as hand/contact lay-up and spray lay-up, respectively), which is then allowed to cure to form the composite product. Once placed in the open mold, the pre-pregs are simply allowed to cure to the mold form. When a flexible vacuum bag is applied to the part during the curing stage of these traditional open molding processes, atmospheric pressure can provide a slight improvement in the consolidation of the laminate prior to curing (this modification is sometimes referred to as “wet-preg vacuum bagging”).

However, there is a mix of benefits and drawbacks in the prior art use of making fiber reinforced open mold laminates. For instance, such open mold processing has relatively low start-up and implementation costs for limited-run or customized part production. Problems associated with open mold processing include: high emissions of volatile organic compounds, and particularly uneven distribution of the resin within the fiber structure. Such flawed resin distribution often results in over-saturated and/or under-saturated areas; the formation of air voids and bubbles; and the use of excess resin or waste of resin in the process. Furthermore, commonly employed open molding unit production costs remain relatively high due to the labor-intensity and limited product throughput.

Alternatively, closed mold resin infusion techniques have also been used. In closed mold processing, fiber and/or other reinforcement(s), collectively referred to as the “pre-form,” are cut to fit and then placed in the two-part mold. A method of enclosing and compressing the pre-form against the mold is then employed. The resin is then typically introduced into the pre-form via ports through the enclosure. Upon curing of the resin, the mold enclosure member is first removed, followed by the finished part.

There are two principal closed molded resin infusion techniques commonly used to enclose and compress the pre-form against the mold, and to distribute resin through the pre-form:

Vacuum infusion employs one hard, rigid mold and one flexible bag or membrane that when joined are sealed to form a “closed” mold. Typically before applying the flexible bag or membrane a disposable barrier layer commonly referred to as a peel ply is placed on top of the pre-form. A peel ply allows resin to pass through it but will not adhere to the resin once it has been cured. A disposable infusion medium and/or perforated injection tubing is then placed on top of the peel ply to aid in the delivery and distribution of the liquid resin down through the laminate stack. In the case of a reusable vacuum bag or membrane the distribution channels may be incorporated into the bag. Vacuum pressure is then applied and resin is drawn through feed-lines into the mold and through the fiber pre-form. The resin is then allowed to cure to form the composite product. Subsequent to resin cure the peel ply is removed, facilitating removal and disposal of the infusion medium and aligned infusion materials.

This technique is commonly referred to as surface vacuum infusion processing since the resin is introduced at the top surface of the laminate. Numerous past efforts have addressed the problems of vacuum bag forming fiber-reinforced resin composites, and in particular for achieving a more uniform distribution of resin throughout the fiber reinforcement layers.

Seemann U.S. Pat. No. 4,902,215 describes numerous earlier approaches and attempts to solve this problem and the difficulties encountered therewith. This '215 patent proposed instead the use of special spaced apart and separated props or pillars to support and prevent contact with outer fluid impervious sheet enclosing the lay-up. These pillars are then provided with a network of parallel-aligned monofilaments thereon to maintain the above separation and to provide the desired channels for resin distribution in the composite.

Seemann U.S. Pat. No. 5,052,906 describes an improved vacuum bag apparatus for making various shaped products, featuring resin distribution of both sides of a woven or felted fiber or fabric. This '906 patent features special opposing resin distribution sheets on the outer surfaces of the laminate in an attempt to achieve more complete resin distribution through and within the lay up sheets. These sheets are specially designed with an open array of raised segments providing vertically oriented spaced-apart props or pillars to support the fluid impervious outer sheets, and in part to attempt to have the vacuum forces applied more uniformly across the fabric assembly.

Another Seemann U.S. Pat. No. 5,601,852 describes a variation of the '906 system wherein the resin distribution channels are molded from a reusable silicone rubber compound in an attempt to provide with the vacuum bag technique the desired more uniform pressure and distribution structure for the fiber reinforced composite product. Resin introduction is here made from a centrally located region of the mold.

On the other hand, resin transfer molding employs two hard, rigid mold parts. After first placing the required fiber/fabric laminate stack in one mold part, the other mold part is then joined together with it and sealed and to form an open cavity into which liquid resin is thereafter introduced. The resin may be introduced with or without the aid of vacuum or applied pressure.

Various combinations and modifications of vacuum infusion, resin transfer molding and other techniques can also be employed and will be recognized by those familiar with and skilled in the state of the art.

There are a number of benefits and drawbacks of prior art in closed molded resin infusion. Importantly, however, a number of benefits can be derived through the use of vacuum infusion vis-à-vis known open molding and resin transfer molding techniques.

Compared to open molding, labor requirements may be reduced and the rate of production from each mold can be improved. For example, labor involved in manually rolling out air bubbles and effecting adequate distribution of the resin is reduced since the vacuum technique improves the distribution of resin throughout the pre-form.

Vacuum infusion also assists in maintaining more consistent resin-to-fiber or fabric ratios by providing the fabricator with the ability to more precisely control the resin input. Product quality and strength are improved since the vacuum also removes trapped air and serves to insure tight bonding of all materials in the lay-up. Compared to resin transfer molding, vacuum infusion requires less set-up time and has much lower tooling costs.

Nonetheless, resin transfer molding has the inherent risk of fiber washout and/or fiber movement or displacement due to forces exerted by the resin flow, as well as resin racing or non-wetting in areas of complex shape or having varying thickness of the part. Surface vacuum infusion also has an inherent risk of resin pooling in low-lying areas due to loss of vacuum pressure after the passage of the resin flow front. The greatest drawback of surface vacuum infusion is still high waste and non-profit stream costs in the disposal of peel plies and surface infusion media.

### SUMMARY OF THE INVENTION

The present invention relates generally to closed molded resin infusion and resin transfer molding techniques for the production of fiber reinforced resin plastic (composite) structures in these and other industries.

More specifically this invention relates to the use in resin infusion and resin transfer molding processing of open grid uni-directional and/or bi-direction fabrics produced by warp insertion, weft insertion, and/or pillar stitch knits that are flat, circular, warp or weft knit or woven. The resulting fiber reinforced plastics may form part of or all of the composite laminate.

The invention also provides the novel use of open grid fabrics as surface infusion media for the purposes of improving upon the prior art surface vacuum infusion techniques, described in greater detail below.

Features essential to the '215, '906 and '852 systems, are not necessary in the present invention.

In contrast, in this present invention an open grid fabric serves as an interlamina infusion medium that significantly improves the speed, uniformity and ability to quality-control the transfer, delivery and distribution of matrix resin (plastic) throughout the laminate stack. The resulting utility of the reinforcing composite lamina product formed is far superior to that of any other product or process in prior art or presently on the market, having dramatically improved mechanical and structural properties. The finished composite part may then be applied in the manufacture of parts and finished goods in the aforementioned and other industries.

An object of the present invention is to provide a novel combination of an open grid fabric resin infusion media and reinforcing composite lamina to overcome the shortcomings of the prior art processes and products.

A further object of the present invention is to provide a novel combination utilizing an open grid fabric resin infusion media and reinforcing composite lamina for use in resin infusion processes for composite manufacturing.

Another object is to provide a novel combination of an open grid fabric resin infusion media and reinforcing composite lamina whereby improved resin infusion rates may be achieved, while maintaining the desired thorough resin saturation of the laminae forming the composite product.

Still another object is to provide a novel combination of an open grid fabric resin infusion media and reinforcing composite lamina to improve the uniformity of the laminate.

Other objects and advantages of the present invention will become apparent to the reader and it is intended that these objects and advantages be within the scope of the present invention.

In these respects, the use of open grid fabric interlamina infusion media and reinforcing composite lamina to aid in the transfer, delivery and distribution of resin according to the present invention substantially departs from the conventional concepts and designs of the prior art. In so doing, it provides a technique and use of a material that has been here primarily developed for the purpose of increasing the resin distribution rate and uniformity throughout the lay up while also improving the resulting mechanical properties of the composite.

Thus, in seeking to improve over the foregoing disadvantages inherent in the known types of resin infusion techniques now present in the prior art, the present invention provides a new technique for resin infusion through the novel use of an open grid fabric interlamina resin infusion media and reinforcing composite lamina in the lay up.

Accordingly, the general purpose and objective of the present invention is to employ an open grid fabric, discussed above, for the resin infusion media and reinforcing composite lamina while retaining the other advantages of the resin infusion techniques, as mentioned heretofore.

Open grid fabrics are themselves already known and are the subject of a number of patents, although in quite unrelated fields. They are sometimes referred to as “geotextile” fabrics with the predominant use being for earthen reinforcement of retaining walls, embankments, slopes and related structures. Open grid fabrics are also known in the garment industry to provide a foraminous open hole mesh structure, and advantageously have a knitted construction, with or without bonding between adjacent yarns. U.S. Patents illustrating such open grid or mesh structures include Viel, U.S. Pat. No. 4,563,382, Bruner, U.S. Pat. No. 5,795,835, Paulson U.S. Pat. No. 6,171,984, Kittson, U.S. Pat. No. 6,368,024 and West, U.S. Pat. No. 6,446,472, each incorporated herein by reference.

While known for those other utilities, these fabrics have heretofore not been employed for the present utilization thereof as a vacuum infusion medium to fabricate fiber-reinforced laminate composite articles.

Accordingly, the present invention has as its objective to provide a novel technique for resin infusion to produce a reinforcing composite lamina by the use of an open grid fabric as the interlamina resin infusion media and in the lay up.

The general purpose and objective of the present invention is thus to provide an improved resin infusion media and reinforcing composite lamina consisting essentially in the use of the aforesaid open grid fabric as an element in the lamina layup or stack. The otherwise general advantages of the resin infusion techniques mentioned heretofore are retained. This resulting technique has entirely novel features and advantages that are neither anticipated nor rendered obvious by the prior resin infusion art.

What has been surprisingly discovered is that the open mesh fabric used as all or part of an interlamina infusion media and laminate stack according to this invention provides an improved speed and uniformity of resin distribution. This reinforcing open grid composite lamina within the laminate also improves the resultant mechanical properties of the composite part.

As used herein, an “open grid” textile or fabric refers to knitted or woven fabrics having, e.g., the characteristics variously illustrated in the above-mentioned patents. They are distinguished from other fabrics by an open mesh, foraminous textile structure, having a dominant apertured construction wherein the fiber or yarn components occupy substantially less than the apertured voids of the textile material. By “substantially less” is meant that the textile will have less than about 50%, preferably less than about 75%, and more preferably less than about 90%, of the volume occupied by the fiber or yarn, exclusive of any void space within such fiber or yarn itself. Such “open mesh” fabrics include those of a ribbed construction, in which case the said apertured voids would include the interstitial spaces between the ribs. As illustrated in West U.S. Pat. No. 6,446,472, for instance, this can take the form of effectively adding a third dimension of raised or ribbed members, with an appropriate ratio of holes located in the fabric as is desired and would be selected by and within the skill of the practitioner of this invention.

Typically, and preferably (although not necessarily), crossings contacts of the respective fibers and yarns may be bonded together and to each other to aid in maintaining the dimensional stability of the open grid or mesh fabric, all in addition to the dimensional stability contributed by the knitting or woven constructions as illustrated in these several referenced patents. Alternatively, a suitable sizing material may be employed.

Surface resin infusion is generally a one-sided process in which the resin flows from the top down through the laminate stack. The open grid fabric as used in this invention can be sandwiched either in the middle and/or placed on either or both sides of the laminate schedule. As such, it serves as both an interlamina infusion medium and as a reinforcing composite lamina. Or the open grid fabric may be used through or in a ply stacking sequence, to promote and aid the rapid and uniform distribution of resin on all sides of the dry laminate. This innovation greatly speeds infusion and improves composite part quality.

The use of an open grid fabric resin infusion media and reinforcing composite lamina can also assist, as desired, to increase laminate thickness, thus also allowing for better visual quality control for thicker composite products. That is the resin flow front line can readily be seen through the bag as it flows or comes up through the laminate stack or plies.

The invention may be applied to the production of composite parts and/or finished goods for use in the automotive, recreation vehicle, trucking, aerospace, marine, rail, appliance, athletic equipment, container, construction, anti-corrosion, electrical and medical industries.

To further illustrate the invention in certain useful but non-limiting embodiments, reference is made to the accompanying drawings.

### BRIEF DESCRIPTION OF THE DRAWINGS

FIG. 1 includes FIG. 1A, which is a cross sectional view, and FIG. 1B, a partial exploded top view, of a typical vacuum infusion mold assembly comprised of a rigid mold and a flexible bag or membrane disposed thereon, but with an open grid fabric resin infusion medium of the invention and reinforcing composite lamina placed in the laminate, or ply stacking sequence.

FIG. 2 shows FIG. 1A with vacuum applied, and thus with the fabric laminae compressed in the mold.

FIG. 3 illustrates in plan view a general construction of a non-limiting suitable open grid fabric for use in this invention.

FIG. 4 schematically illustrates a cross section of the open grid fabric shown in FIG. 3.

FIG. 5 illustrates schematically a cross sectional (FIG. 5A) and top plan view (FIG. 5B) of a bi-directional open grid fabric form that may be used in practice of the present invention.

FIG. 6 illustrates schematically a top plan view (FIG. 6A) and a cross-sectional view (FIG. 6B) of an alternate embodiment of the open grid fabric that may also be used in practice of the present invention.

FIG. 7 illustrates schematically a top plan view of a warp knit pillar ribbed fabric for use in the invention.

FIG. 8 illustrates an exploded schematic plan view of one wale of the open chain stitch that provides the rib of the warp knit pillar ribbed fabric of FIG. 7.

FIGS. 9A and B comprise a warp knit guide bar-lapping diagram of the warp knit pillar-ribbed fabric of FIGS. 7 and 8.

FIG. 10 is an infusion experimental set up.

FIG. 11 is a plot of comparison resin infusion rate curves using the set up of FIG. 10.

### DETAILED DESCRIPTION OF THE PREFERRED EMBODIMENTS OF THE INVENTION

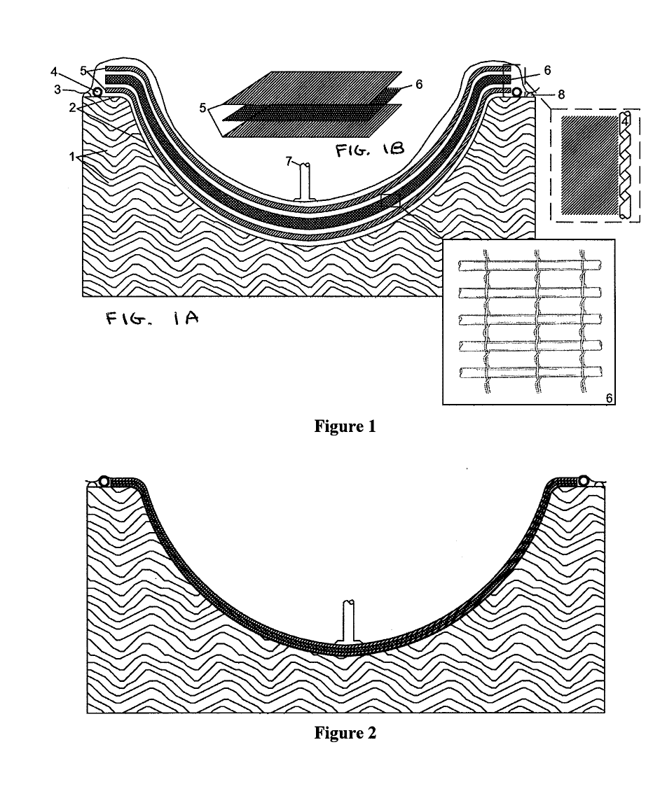

In the drawings, FIG. 1 is a cross sectional view of a typical vacuum infusion mold assembly comprised of one rigid mold 1 having a shaped mold surface or face 2 and one flexible bag or membrane 3, but with an open grid fabric resin infusion medium employed and reinforcing composite lamina placed in the laminate, or ply stacking sequence. The vacuum bag 3 is placed over the open mold, and is associated with the perforated resin infusion tubing 4 (shown in cross sectional and top plan views). The laminate layup is composed of fibrous lamina 5, an open grid fabric layer 6 (also shown in top plan view), and a vacuum tubing inlet 7, and with a sealant tape 8.

As shown in FIG. 1, dry fiber reinforcement is laid into a mold of the desired shape 1. In this example, the open grid fabric 6 is placed between two layers of fiber reinforcement or lamina 5 to make up the laminae. A flexible sheet of plastic 3 is placed over the mold and laminate. The edges of the sheet are sealed against the mold, in this example with sealant tape 8 to form a sealed envelope surrounding the laminate. Vacuum pressure is then drawn through one or more strategically located ports 7 in the mold or plastic cover to collapse the flexible sheet against the reinforcement. The vacuum serves to shape the fibers to the mold, provide consolidation of the fibers via atmospheric pressure, and to remove any entrapped air, as shown in FIG. 2. Resin is then introduced into the envelope via perforated feed-lines, in this example spiral wrap 4 is used, and the vacuum serves to draw the resin through the fiber pre-form via the open path afforded by the open grid fabric. Vacuum pressure is maintained until the laminate is fully saturated with resin and subsequently cures.

FIG. 2 illustrates the configuration of the device of FIG. 1 with the vacuum applied and resultant compression of the layup.

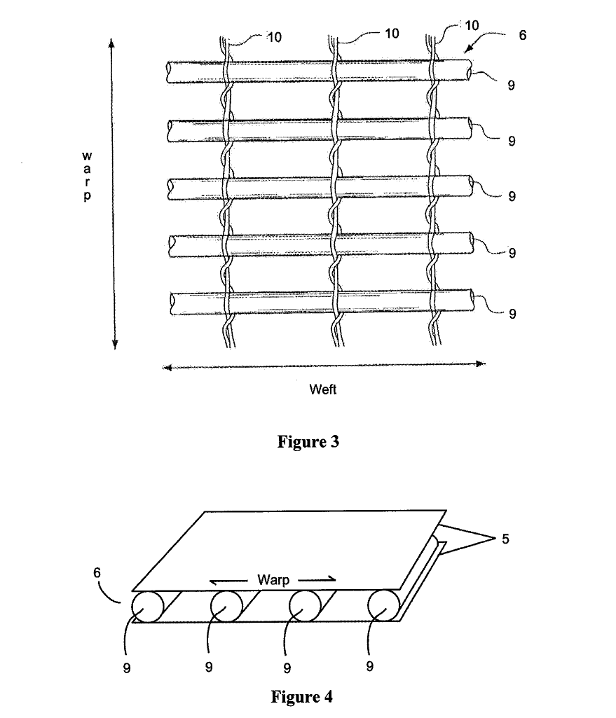

FIG. 3 schematically shows a general construction of a suitable fabric for use as the open grid fabric resin infusion media and reinforcing composite lamina 6. The fabric depicted in FIG. 3 is a unidirectional fabric. As used herein, the term “unidirectional” is construed to mean a fabric having its major strands extending in one or the other, but not both, of the longitudinal (i.e., “warp” or “machine”) direction and the transverse (i.e., “weft” or “cross-machine”) direction of the fabric. Thus, the fabric illustrated in FIG. 3 is transverse unidirectional in that it includes a plurality of spaced apart weft strands 9 such as bundled rovings or the like which are loosely stitched together by warp strands 10, sometimes referred to as tying members. The fibers comprising the warp 10 and/or weft strands 9 can include fibers formed from various materials such as natural materials (e.g. cotton, flax, etc.), polymeric materials (e.g. polyesters, polyamides, etc., inorganic materials (e.g. glass fibers, carbon fibers, etc.), and combinations thereof.

FIG. 4 is a cross section of FIG. 3 wherein fabric 6 is applied as in FIGS. 1 and 2, and where fibrous lamina 5 are present on both sides of open grid fabric 6, under vacuum. In one preferred embodiment of this invention the open grid fabric is constructed such that open paths are maintained within said grid fabric when subjected to vacuum compression thereby permitting the resin to flow freely throughout said laminate. This quality can be imparted to the fabric 6 through the selected construction technique, construction architecture, construction material, stabilizing coatings or sizings, or a combination thereof.

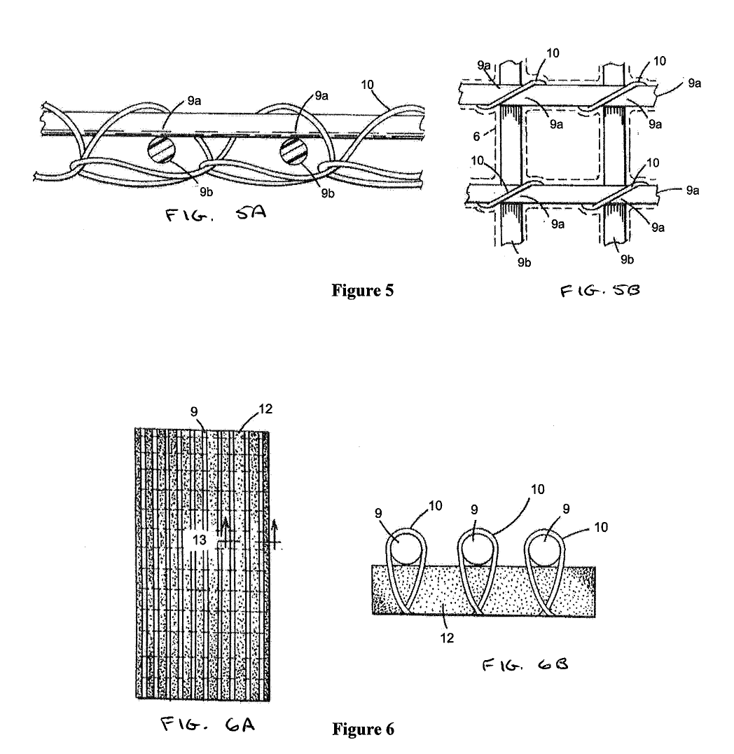

FIG. 5 is a cross sectional and top plan view of a bi-directional form of open grid fabric 6. As used herein, the term “bi-directional” is construed to mean a fabric having its major strands extending in both the longitudinal (i.e., “warp” or “machine”) direction and the transverse (i.e., “weft” or “cross-machine”) direction of the fabric. In this regard, the fabric of FIG. 5 is bi-directional in that it includes a plurality of spaced apart weft strands 9a and warp strands 9b, such as bundled roving or the like which are loosely stitched together by weft strands 10. A bi-directional fabric may be used where it is desired to have the resin flow, as shown in FIG. 4, in more than one direction. Multiple variations of bi-directional open grid textiles are disclosed in the prior art such as U.S. Pat. No. 6,171,984 B1, incorporated herein by reference

FIG. 6 is a top plan view and a cross-sectional view of an alternate embodiment of the present invention illustrating the association of a composite lamina 12 with an open grid fabric 6. While FIG. 6 depicts the use of a unidirectional fabric, with flow direction arrows indicated as 13. As depicted in FIG. 5, a bi-directional fabric may also be used within this embodiment. This approach also provides for the capability to produce pre-designed, “out-of-the-box” laminates, optionally with layers stitched together, with the advantage of further reducing manufacturing time and aiding the prevention of fiber washout or movement/displacement during resin transfer molding.

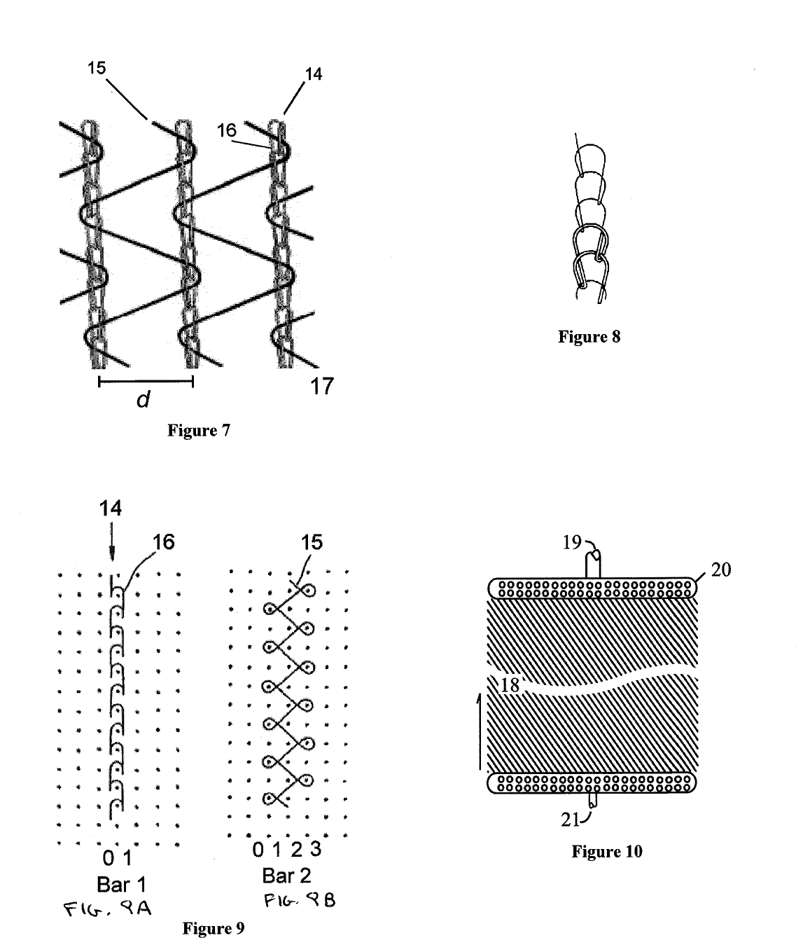

FIG. 7 illustrates a top plan view of a warp knit pillar (chain) stitch 14 open grid fabric 17 created via warp knitting or the like, while a connecting underlap by horizontal yarns is produced every few courses 15 as explained further below.

FIG. 8 illustrates an exploded schematic plan view of the knitting yarn 16 of fabric 17 showing one wale 14 of the open chain stitch that provides the rib, as explained further below.

FIG. 9 is warp knit guide bar-lapping diagram with point paper notations (the needle heads being represented as dots) of a portion of a said suitable ribbed open grid textile 17. In FIG. 9 Guide Bar 1 is shown to undergo a 0-1/1-0 repeat motion in order to produce a wale 14 defined by the same warp yarn 16. In order to create a knit fabric, a weft yarn 15 is knitted which acts to link wales 14 using a fully threaded Bar 2 undergoing a 1-0/2-3 repeat lapping motion, as explained further below.

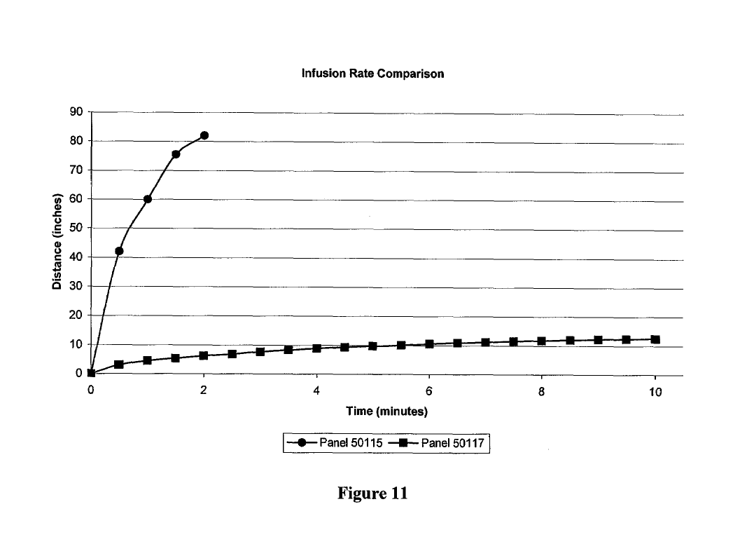

FIG. 10 illustrates an infusion rate experimental set-up wherein 18 depicts the laminae under test, 19 depicts the vacuum port, 20 depicts the dimpled polyethylene flow path interface, and 21 depicts the resin inlet port, as explained further below.

FIG. 11 illustrates a resin infusion rate curve comparing the use an open grid fabric of the present invention in a typical lamina schedule to the same lamina schedule without use of said open grid fabric, as is explained further below.

As stated, this invention advantageously utilizes open grid fabrics in resin infusion and resin transfer molding processing of fiber reinforced plastics as a part of or all of the composite laminate to act as both an interlamina infusion medium and reinforcing composite lamina. Such use significantly improves the speed, uniformity and ability to quality-control the transfer, delivery and distribution of matrix resin (plastic) throughout the laminate stack. The resulting utility is well beyond that of any other product or process in prior art or on the market. As a reinforcing composite lamina the use according to this invention of the open grid fabric improves mechanical and structural properties in the finished composite part (e.g., increasing the fiber-to-resin ratio to aerospace grade percentages of 70%+, significantly improving the strength-to-weight ratio, significantly improving damage tolerance, creating a “living hinge” upon failure) as applied, for instance, to the manufacture of parts and finished goods in automotive, marine, aeronautical, and other industries.

The open grid fabric of the invention comprises an open grid uni-directional and/or bi-direction fabric which may be produced by warp insertion, weft insertion, and/or pillar (chain) stitch knits that are flat, circular, warp or weft knit or woven. The open grid fabric may optionally be coated with a curable resinous material or a sizing rendering the fabric semi-rigid. The handling of the fabric is thereby facilitated and provides a fiber composition of suitable compatibility with the composite matrix. The open grid fabric in question may be manufactured using machines that include, but in no way are limited to, single and double needle bar warp knitting machines, single and double needle bar weft knitting machines, circular knitting machines, and weaving looms, as illustrated in part in the patents referred to above.

A non-limiting example of a warp knit weft inserted fabric, is disclosed in U.S. Pat. No. 6,368,024 B2 “Geotextile Fabric”, incorporated herein by reference, and may be prepared using 2000 tex rovings of continuous filament fiberglass in cross machine (weft) direction. These rovings may be joined together by any conventional stitching, weaving, knitting or related process using 1000 denier continuous filament polyester thread to a structure having openings of from about 1/16″ to about 6″ on a side. The structure is thereafter coated, in this example with PVC plastisol, to stabilize said product. The resulting grid may weigh from about 25 to 10,000 grams per square meter and may have a tensile strength across the width of about 10 to about 400 kN/m.

Another non-limiting example of an open grid textile of the present invention is disclosed in US Patent Application US2001/0025817 A1 incorporated herein by reference; wherein a preferably knitted or woven textile is disclosed to have a surface defined by a plurality of parallel ribs to provide for fluidic passage in a filter assembly application, the ribs being knitted or woven to be non-compressible in order to resist collapse in said application. For use in accordance with the present invention, the ribs are knitted or woven to be sufficiently non-compressible in order to resist collapse of said fluid channels during compression of the composite preform under vacuum induced pressure.

Another aspect of the present invention can be utilized in the production of composite parts using resin transfer molding and its variants. Another aspect of the present invention can be utilized in the production of composite parts using a combination of vacuum infusion and resin transfer molding.

### Non-limiting Example of the Invention

The following is an example of the practiced invention utilizing a warp knit pillar ribbed fabric architecture, an example of which is shown schematically in FIG. 7 (17).

As indicated above, one form of the open grid textile 17 may be a warp knit fabric and wales of knitted stitches preferably form the ribs. The plurality of generally continuous ribs are spaced apart by a distance, d (see FIG. 7), where distance d is dependant upon the gauge of machine on which the fabric is knitted and the size of the yarns making up the fabric. Typically it is envisaged that the fabrics will be knitted on machines having a gauge between 6 and 22. FIG. 8 is an exploded schematic plan view of the knitting yarn of textile 17 showing one wale of the open chain stitch that provides the rib.

In use the ribbed textile surface 6 is arranged in face-to-face contact with the adjacent lamina of the preform, 5. The ribs are knitted or woven to be sufficiently non-compressible in order to resist collapse of said fluid channels during compression of the composite preform under vacuum induced pressure. In this manner rapid transport of the resin is affected during resin infusion.

Further to the example, FIG. 9 is a warp knit guide bar-lapping diagram with point paper notations (the needle heads being represented as dots) of a portion of a said suitable ribbed open grid textile 17. In FIG. 9 Guide Bar 1 is shown to undergo a 0-1/1-0 repeat motion in order to produce a wale 14 defined by the same warp yarn 16. Preferably Bar 1 is fully threaded (full set) although it is envisaged that bar 1 may be partially threaded (e.g. one in—one out: i.e., half set) in order to provide a greater d dimension. In order to create a knit fabric, a weft yarn 15 is knitted which acts to link wales 14 using a fully threaded Bar 2 undergoing a 1-0/2-3 repeat lapping motion.

Typically the yarn count for yarn 16 is about 110 tex and for yarn 15 about 18 tex.

Typically yarns 16 and 15 are non-texturized yarns; preferably polyester, but could be any one of the contemplated yarns or combinations thereof.

Preferably the fabric is heat set after knitting and is also subject to a finishing process in order to remove lubricants, conditioners, etc from the yarn. The fabric may also be finished with a form of resin coating, such as an acrylic, that acts to further stabilize the open grid (ribbed) mesh architecture from deformation during application and processing.

In accordance with the present invention the following open grid (ribbed) textile (Cortina Fabrics, Inc. Fabric Number C291-10) (our notebook JJ-XXX) was used in infusion rate trials:

| | |
|---|---|
| Fabric Finish: | Acrylic resin coating. |
| Weight per square metre: | c. 290 gms. |
| Courses per metre: | 400 (finished state). |

Construction: A 2 guide bar warp fabric, with both bars knitting at 6 gauge. Bar 1 is farther from the technical fabric face.

Pattern chain: Bar 1—Chain stitch-01/10.

Bar 2—2 & 1 Tricot-10/23.

Yarn: Bar 1—110 tex textured polyester at 2 ends per guide.

Bar 2—18 tex texturized polyester at 1 end per guide.

The standard vacuum/laminae cell is shown schematically (top view) in FIG. 10 where the laminae 18 consisted of2 oz./ft.² chopped strand mat (Owens Coming M723A)/Cortina C291-10/2 oz./ft.² chopped strand mat measuring 12 inches in width by 84 inches in length. The general assembly of the standard cell is representative of interlaminar infusion, shown schematically in FIGS. 1 and 2, where the Cortina C291-10 is a reinforcing interlaminar infusion media 6.

Referring again to FIG. 10, upon assembly of the laminae 18, a single 0.75 inch (ID) vacuum port 19 was through fitted to a 2 inch by 12 inch strip of Naltex dimpled polyethylene sheet 20, fitted dimple down and affixed adjacent to the laminae 18. The dimpled polyethylene 20 provides an experimentally repeatable flow path at the vacuum-laminae interface. A 0.375 inch (OD) resin input tube 21 was then through fitted to a 2 inch by 12 inch strip of Naltex dimpled polyethylene sheet 20, fitted dimple down and affixed adjacent to the laminae 18 on the opposite edge of the flow medium to that of the vacuum port 19. Here the dimpled polyethylene 20 provides an experimentally repeatable flow path at the resin-laminae interface. In this way the cell was set up such that the ensuing flow front path would run perpendicular to the laminae length. The Cortina C291-10 was set up such that the ribs, and hence the fluidic path, ran parallel to the laminae length. A flexible vacuum bag was then fitted and sealed about the laminae, the resin input tube 21 sealed with a clamp and vacuum drawn. To facilitate flow front progression time demarcation a clear vacuum bag was used. The direction of said flow is indicated by the arrow in FIG. 10.

A gauge affixed to a standard resin trap read the vacuum, generated by a Gast 2067 rotary vane pump. When vacuum reached and was stabilized at 27 inches of mercury, the clamp was removed from the resin inlet tube, and the tube was subsequently placed in a vessel containing initiated polyester resin (85 cps Interplastic COR45-187-637 (initiated with 1% DHD-9)). The resin clamp was reaffixed to the inlet tube when the resin front reached the vacuum port. Time interval demarcations were recorded every 30 seconds from the time of resin introduction to infusion completion. In this manner the flow rate afforded by the invention could be quantified.

Two such experiments were performed wherein all variables within the cell were maintained constant, except for the laminae schedule. One experiment was run with the before described laminae, and one wherein an additional laminae was 2 oz./ft.² chopped strand mat (Owens Corning M723A)/2 oz./ft.² chopped strand mat.

FIG. 11 presents a comparative infusion rate curve based on the above experiment. Both Panels #50115 and #50117 were comprised of two layers of Owens Coming M723A 2 oz./ft.² CSM. However, panel #50117 also had an intermediate layer of Cortina fabric number C291-10.

Thus, the data represents, first, Panel #50115, comprised a layer of M723A 2 oz./ft.² CSM, then a layer of Cortina fabric number C291-10, and third a layer of M723A 2 oz./ft.² CSM. For comparison, Panel #50117 is comprised only of two layers of M723A 2 oz./ft.² CSM.

For each example there was a total of 4 oz./ft.² CSM. That is, the difference between the two examples is that Panel #50115 has within it a layer of the Cortina fabric number C291-10, whereas Panel #50117 does not.

From FIG. 11 it can be seen that, all other conditions being equal, the addition of the open grid fabric displays a remarkably increased infusion rate. Within just a little over two minutes in this experiment Panel 50115 with the Cortina laminae the panel was fully saturated and wetted out with the resin. In contrast, the resin flow front for Panel 50117 composed only of the CMS laminae had progressed only to a little more than 10 inches after 10 minutes.

The speed of resin infusion is especially significant because there is always a finite time period before the initiated or catalyzed resin will “kick” and lead to initial formation of a gelation stage, following which further infusion flow will be impeded by the developed viscosity increase, or probably stop all together.

The result of this practice of the invention is a thoroughly resin impregnated composite lamination that is very substantially, if not entirely, free from non-infused voids and/or non-wetted regions (and therefore structurally weak regions) within the laminate structure. It will also be appreciate that a desired laminate stack may have more than one ply of the open grid fabric, placed within or on an outer surface of the stack with a plurality of conventional textiles plies suitably arranged on either side thereof.

For instance, for the one or more lamina other than the open grid fabric, there may be used unidirectional fabrics of various construction, woven or knit fabrics, multiaxial fabrics of stitched construction, or braided fabrics. Fiber types used therein may also be of various compositions, including organic, such as, polyester, aramid (i.e. Kevlar, or Nomex), etc., or carbon fibers, or inorganic, such as glass or ceramic.

The manner of usage and operation of the present invention, and variations and equivalents thereof, will be apparent to those skilled in the art from the above description, and it will be recognized that a wide variety of specific practices may be employed.

With respect to the above description and example, it is also to be recognized that the optimum dimensional relationships for the parts of the invention, may include variations in size, materials, shape, form, function and manner of operation, assembly and use.

Therefore, the foregoing specific working embodiment is considered as illustrative only of the principles of the invention. Further, since numerous modifications and changes thereto may be made by those skilled in the art, without departing from the spirit of this invention, which is limited only by the scope of the following claims.

We claim:

1. A vacuum induced resin infusion process for forming a fiber reinforced composite laminate, comprising:
forming an assembly of at least two plies of fibrous textile material, wherein one such ply is composed of an open grid uni-directional or bi-directional mesh fabric having a substantially foraminous construction of respectively spaced apart fibers or yarns wherein less than about 50% of the textile volume is occupied by the fiber or yarn, and at least one other additional ply is arranged adjacent to said open grid ply, said additional ply or plies being suitable for fibrous reinforcement of a composite laminate, and wherein said fibers or yarns of said respective layers or plies are composed of natural, polymeric, or inorganic fibers, or combinations thereof;
enclosing said assembly within a substantially air impervious envelope covering;
applying a vacuum to at least one edge or side of the said envelope; and
introducing a curable resin to at least one opposite edge or side of said envelope, whereby aided by the foraminous nature of said open grid fabric the said curable resin flows rapidly at a speed sufficient to enable resin penetration and saturation throughout the fibrous textile assembly prior to a gelation point of the resin, to form, after at least substantial completion of resin curing, a fiber reinforced composite structure.

2. The process of claim 1 wherein said open grid fabric layer or ply has less than about 25% of the textile volume occupied by the fiber or yarn.

3. The process of claim 1 wherein said open grid fabric layer or ply has less than about 90% of the textile volume occupied by the fiber or yarn.

4. The process of claim 1 wherein the open grid fabric is produced by warp insertion, weft insertion, or pillar stitch knits that are flat, circular, warp or weft knit.

5. A vacuum induced resin infusion process for forming a fiber reinforced composite laminate, comprising:
forming an assembly of at least two dry plies of fibrous textile material, wherein one such ply is composed of an open grid uni-directional or bi-directional mesh fabric having a substantially foraminous construction of respectively spaced apart fibers or yarns wherein less than about 50% of the textile volume is occupied by the fiber or yarn, and at least one other additional ply is arranged adjacent to said open grid ply, said additional ply or plies being suitable for fibrous reinforcement of a composite laminate, and wherein said fibers or yarns of said respective layers or plies are composed of natural, polymeric, or inorganic fibers, or combinations thereof;
enclosing said assembly within a substantially air impervious envelope covering, fitted with at least one first means for applying a vacuum and at least one second means for supplying a curable resin to within said envelope;
applying a vacuum to at least one edge or side of the said envelope; and
introducing said curable resin to at least one opposite edge or side of said envelope, whereby aided by the foraminous nature of said open grid fabric the curable resin flows rapidly at a speed sufficient to enable resin penetration and saturation throughout the fibrous textile assembly prior to a gelation point of the resin, to form, after at least substantial completion of resin curing, a fully saturated fiber reinforced composite structure.

6. The process of claim 5, where the fibers or yarns are non-texturized yarns.

7. The process of claim 6, where the non-texturized yarns are polyester.

8. The process of claim 5, where the fibers or yarns are multi-filament fibers or yarns.

9. A vacuum induced resin infusion process for forming a fiber reinforced composite laminate, comprising:
forming a stack having at least two dry plies of fibrous textile material, wherein at least one ply is a layer of an open grid uni-directional or bi-directional mesh fabric, having a substantially foraminous construction of respectively spaced apart fibers or yarns wherein less than about 50% of the textile volume is occupied by the fiber or yarn, and at least one ply is an additional fabric layer adjacent to one side of the open grid fabric, the additional fabric layer contributing to fibrous reinforcement of the composite laminate;
enclosing the stack within a substantially air impervious envelope;
applying a vacuum to the envelope;
introducing a liquid resin into the envelope, where the resin distribution within the stack is aided by the open grid fabric;
fully saturating the stack with the resin; and
curing the stack, to embed the stack in the cured resin and thereby form the fiber reinforced composite laminate.
